(19) United States
(12) Patent Application Publication
(10) Pub. No.: US 2026/0222054 A1
(43) Pub. Date: Jul. 30, 2026

(54) METHOD AND APPARATUS FOR PROCESSING TRANSMISSION PROFILE IN WIRELESS COMMUNICATION SYSTEM

(71) Applicant: SAMSUNG ELECTRONICS CO., LTD., Suwon-si, Gyeonggi-do (KR)

(72) Inventors: Hyunjeong KANG, Suwon-si (KR); Sangyeob JUNG, Suwon-si (KR)

(21) Appl. No.: 19/148,983

(22) PCT Filed: Jan. 17, 2024
(86) PCT No.: PCT/KR2024/000847

§ 371 Date: Jul. 17, 2025

(30) Foreign Application Priority Data
Jan. 20, 2023 (KR) 10-2023-0008487

(51) Int. Cl. H04B 7/185

(52) U.S. Cl. CPC H04B 7/18504

(57) ABSTRACT

The present disclosure relates to a 5G or 6G communication system for supporting a higher data transmission rate. A method performed by a UE in a wireless communication system, according to the present disclosure, may comprise the steps of: determining TX profile configuration information for transmitting at least one of a UAV service message and a UAM service message; on the basis of the TX profile configuration information, configuring a radio transmission parameter applied to at least one of the UAV service message and the UAM service message; and transmitting at least one of the UAV service message and the UAM service message to another UE by applying the radio transmission parameter.

### [Technical Field] [1]

The disclosure relates to a wireless communication system. More particularly, the disclosure relates to a method and an apparatus for processing a wireless transmission profile used when an unmanned aerial terminal transmits and receives a U2X communication-based service message through a PC5 interface in a wireless communication system.

### [Background Art] [2]

5G mobile communication technologies define broad frequency bands to enable high transmission rates and new services, and can be implemented not only in “Sub 6 GHz” bands such as 3.5 GHz, but also in ultrahigh frequency (“Above 6 GHz”) bands referred to as mmWave such as 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIOT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The disclosure is to provide an apparatus and a method capable of effectively providing services in a wireless communication system.

### Solution to Problem

According to an embodiment of the disclosure, a method performed by a UE in a wireless communication system may include determining TX profile configuration information for transmitting at least one of a UAV service message or a UAM service message, configuring a radio transmission parameter applied to at least one of the UAV service message or the UAM service message, based on the TX profile configuration information, and applying the radio transmission parameter to transmit at least one of the UAV service message or the UAM service message to another UE.

### Advantageous Effects of Invention

Provided according to embodiments proposed in the disclosure are an apparatus and a method capable of effectively providing services in a wireless communication system.

Advantageous effects obtainable from the disclosure may not be limited to the above-mentioned effects, and other effects which are not mentioned herein may be clearly understood from the following description by those skilled in the art to which the disclosure pertains.

### BRIEF DESCRIPTION OF DRAWINGS

FIG. 1 illustrates a scenario of supporting an unmanned vehicle service message in a wireless communication system according to an embodiment of the disclosure.

FIG. 2 illustrates a scenario of supporting an unmanned vehicle service message in a wireless communication system according to an embodiment of the disclosure.

FIG. 3 illustrates an operation of a UE that processes a wireless transmission profile for transmitting a service message in a wireless communication system according to an embodiment of the disclosure

FIG. 4 illustrates an operation of the UE that processes a wireless transmission profile for transmitting a service message in a wireless communication system according to an embodiment of the disclosure.

FIG. 5 illustrates an operation of the UE that processes a wireless transmission profile for receiving a service message in a wireless communication system according to an embodiment of the disclosure.

FIG. 6 illustrates the operation of the UE that processes a wireless transmission profile for receiving a service message in a wireless communication system according to an embodiment of the disclosure.

FIG. 7 is a flowchart illustrating the signal flow between UEs that process a wireless transmission profile for an unmanned vehicle service message in a wireless communication system according to an embodiment of the disclosure.

FIG. 8 illustrates a structure of a UE according to an embodiment of the disclosure.

### MODE FOR THE INVENTION

UE-to-UE direct communication (sidelink communication) using a 5G communication system is being studied, and it is expected that the UE-to-UE direct communication is applied to, for example, vehicle-to-everything (hereinafter, referred to as “V2X”), a public safety network, and drone communication and may thus provide various services to a user.

An embodiment of the disclosure is to provide a method and an apparatus for processing a TX profile, that is, a wireless transmission profile for transmitting and receiving a service message of an unmanned aerial vehicle in a wireless communication system supporting unmanned aerial vehicles.

The technical subjects pursued in the disclosure may not be limited to the above-mentioned technical subjects, and other technical subjects which are not mentioned herein may be clearly understood from the following description by those skilled in the art to which the disclosure pertains.

An embodiment of the disclosure can provide safe drone communication or urban air mobility communication in a wireless communication system.

Hereinafter, exemplary embodiments of the disclosure will be described in detail with reference to the accompanying drawings. It should be noted that, in the accompanying drawings, the same or like elements are designated by the same or like reference signs as much as possible. Also, a detailed description of known functions or configurations that may make the subject matter of the disclosure unnecessarily unclear will be omitted.

In describing the embodiments in the specification, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card.

The following detailed description of embodiments of the disclosure is mainly directed to New RAN (NR) as a radio access network and Packet Core (5G system or 5G core network or next generation core (NG Core)) as a core network in the 5G mobile communication standards specified by the 3rd generation partnership project (3GPP) that is a mobile communication standardization group, but based on determinations by those skilled in the art, the main idea of the disclosure may be applied to other communication systems having similar backgrounds through some modifications without significantly departing from the scope of the disclosure.

In the 5G system, a network data collection and analysis function (NWDAF), which is a network function for analyzing and providing data collected in a 5G network, may be defined to support network automation. The NWDAF may collect/store/analyze information from the 5G network and provide the results to unspecified network functions (NFs), and the analysis results may be used independently in each NF.

In the following description, some of terms and names defined in the 3rd generation partnership project long term evolution (3GPP LTE) standards (standards for 5G, NR, LTE, or similar systems) may be used for the convenience of description. However, the disclosure is not limited by these terms and names, and may be applied in the same way to systems that conform other standards.

In the following description, terms referring to signals, terms referring to channels, terms referring to control information, terms referring to network entities, terms referring to device elements, and the like are illustratively used for the sake of descriptive convenience. Therefore, the disclosure is not limited by the terms as used herein, and other terms referring to subjects having equivalent technical meanings may be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. However, they are merely examples thereof, and the base station and the terminal are not limited to these examples. In the disclosure, the term “eNB” may be interchangeably used with the term “gNB” for the sake of descriptive convenience. That is, a base station described as “eNB” may refer to “gNB”. In the disclosure, the term “terminal” may refer to not only mobile phones, NB-IOT devices, and sensors, but also various wireless communication devices.

In the following description, the terms “physical channel” and “signal” may be interchangeably used with the term “data” or “control signal”. For example, the term “physical downlink shared channel (PDSCH)” refers to a physical channel over which data is transmitted, but the PDSCH may also be used to refer to the “data”. That is, in the disclosure, the expression “transmit ting a physical channel” may be construed as having the same meaning as the expression “transmitting data or a signal over a physical channel”.

In the following description of the disclosure, higher signaling refers to a signal transfer scheme from a base station to a terminal via a downlink data channel of a physical layer, or from a terminal to a base station via an uplink data channel of a physical layer. The higher signaling may also be understood as radio resource control (RRC) signaling or a media access control (MAC) control element (CE).

Furthermore, as used in the disclosure, the expression “greater than” or “less than” is used to determine whether a specific condition is satisfied or fulfilled, but this is intended only to illustrate an example and does not exclude “greater than or equal to” or “equal to or less than”. A condition indicated by the expression “greater than or equal to” may be replaced with a condition indicated by “greater than”, a condition indicated by the expression “equal to or less than” may be replaced with a condition indicated by “less than”, and a condition indicated by “greater than and equal to or less than” may be replaced with a condition indicated by “greater than and less than”.

Furthermore, the embodiments of the disclosure will be described using terms employed in some communication standards (e.g., the 3rd generation partnership project (3GPP)), but they are for illustrative purposes only. The embodiments of the disclosure may also be easily applied to other communication systems through modifications.

UE-to-UE direct communication (sidelink communication) using a 5G communication system is being studied, and it is expected that the UE-to-UE direct communication is applied to, for example, vehicle-to-everything (hereinafter, referred to as “V2X”), a public safety network, and drone communication and may thus provide various services to a user.

An embodiment of the disclosure is to provide a method and an apparatus for processing a U2X communication TX profile, that is, a wireless transmission profile for transmitting and receiving a service message of an unmanned aerial vehicle by using a PC5 interface in a wireless communication system supporting unmanned aerial vehicles. The service message of the unmanned aerial vehicle may include, for example, at least one or a combination of information capable of identifying the unmanned aerial vehicle and control information for controlling the unmanned aerial vehicle.

According to an embodiment of the disclosure, by synchronizing a wireless transmission profile between UEs which exchange service messages of the unmanned aerial vehicle in a wireless communication system, secure drone communication and urban air mobility communication may be provided.

The disclosure may provide a method and an apparatus for using a direct communication interface (for example, PC5 or sidelink) between UEs in order to control unmanned aerial vehicles (for example, drone or unmanned aerial vehicle (UAV)) or control air mobility (for example, urban air mobility (UAM)) with no pilots or limited involvement of pilots in a wireless communication system. In the disclosure, a scenario using the direct communication interface between UEs may include a procedure of acquiring UAV identification information or UAM identification information of unmanned aerial vehicles or urban air mobility from an agency that regulates unmanned aerial vehicles or urban air mobility (for example, an agency in charge of low enforcement such as the U.S. Federal Aviation Administration). According to the regulatory policy, the UE mounted on the unmanned aerial vehicle may transmit UAV identification information to a UE managed by the regulatory agency.

According to an embodiment, the UE may transmit UAV identification information or UAM identification information through the direct communication interface between UEs. In the disclosure, in addition to messages including the UAV identification information or the UAM identification information, messages including information required for controlling unmanned aerial vehicles or urban air mobility may be defined as UAV control messages. Of course, the disclosure is not limited to the example, and the UAV control messages may further include various messages.

The UE mounted on the unmanned aerial vehicle, the UE mounted on the urban air mobility, or the UE managed by the regulatory agency (law enforcement) may transmit, receive, and process a UAV control message including required control information through the direct communication interface between UEs. Examples of the scenario using the UAV control message that may be operated according to various embodiments of the disclosure may include the UE identifier broadcasting control and collision detection and collision avoidance control as shown in [Table 1] below. However, the disclosure is not limited thereto.

TABLE 1

Use of U2X (UAV to everything) for BRID (broadcast
remote identification):
the content of the messages for BRID are defined
according to the regional regulations for BRID (e.g. message set
of ASTM F3411.19 or ASD-STAN prEN 4709-002 P1) and
optionally according to regional mean of compliance
documents.
Use of U2X (UAV to everything) for DAA (detect and
avoid):
the content of the messages for DAA are defined
according to the regional regulations for DAA and is out of
scope of this specification.

According to various embodiments of the disclosure, the UAV control message may include remote UE identification (used when a UE identification of unmanned mobility is remotely transmitted), a remote UE identification request (used when a request for transmitting a UE identification of unmanned mobility is remotely made), remote UE positioning information (used when location information of unmanned mobility is remotely transmitted), a remote UE positioning request (used when a request for location information of unmanned mobility is remotely made), remote UE path information (used when a movement path of unmanned mobility is remotely transmitted), a remote UE path request (used when a request for a movement path of unmanned mobility is remotely made), and detect and avoid (DAA) control (used to inform that collision of unmanned mobility is detected or indicate to avoid collision), and may be transmitted through a PC5 interface.

As an embodiment, an unmanned vehicle service message including a UE identifier, that is, a remove UE identification of the unmanned vehicle may include [Table 2] below. However, the disclosure is not limited thereto.

TABLE 2
The message standard of the UE identifier of the unmanned vehicle may include the
following.
Message set of ASTM F3411.19
ASD-STAN prEN 4709-002 P1
Information included in the message standard of the UE identifier of the unmanned vehicle
may include the following.
Standard remote identification: UA ID, UA location/longitude/altitude/speed, CS
location/longitude/altitude, emergency situation, and time mark
Remote identification broadcasting module: module serial number, UA
location/longitude/altitude/speed, and take-off location/longitude/altitude, and time mark
UAS operator registration number, UA unique serial number, time mark, pilot location or
take-off location, and emergency situation information

The unmanned vehicle used in the disclosure may include all of unmanned aerial vehicles and urban air mobility. Of course, the unmanned vehicle is not limited to the example, and may include all types of vehicles in which no person is on board as well as the unmanned aerial vehicle and the urban air mobility.

A method performed by the UE in the wireless communication system may include an operation of determining whether transmission or reception of a UAV (drone) service message or a UAM (urban air mobility) service message is authenticated using PC5 interface-based U2X communication, an operation of determining a TX profile mapped to transmit or receive a service message through PC5 interface-based U2X communication, operation of determining a radio transmission parameter corresponding to the TX profile, an operation of performing transmission or reception by using the radio transmission parameter corresponding to the TX profile, and an operation of transferring a destination layer-2 identifier mapped to a service identifier of the service message, PC5 RAT information mapped thereto, and TX profile information mapped thereto from a higher layer (upper layer) of the UE to an AS layer of the UE.

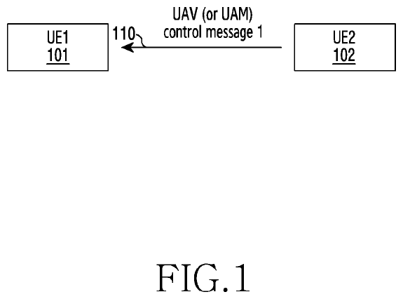

FIG. 1 illustrates a scenario of supporting an unmanned vehicle service message in a wireless communication system according to an embodiment of the disclosure.

Referring to FIG. 1, UE 1 101 and UE 2 102 may be UEs in a wireless communication system supporting an unmanned vehicle. As an example, UE 1 101 may correspond to a UE managed by an agency that regulates unmanned vehicles. UE 2 102 may correspond to a UE mounted on the unmanned vehicle. As another example, UE 1 101 and UE 2 102 may correspond to UEs mounted on the unmanned vehicles. UE 2 102 may broadcast (groupcast or unidirectionally unicast) UAV control message 1 or UAM control message 1 110 to UE 1 101 through a direct communication interface (for example, PC5 or sidelink).

Based on FIG. 1, an example of a scenario in which UE 1 101 and UE 2 102 transmit and receive unmanned vehicle control signaling is described below. UE 2 102 may transmit its own identification information to UE 1 101 by using the direct communication interface (for example, PC5 or sidelink) in order to identify information on the operating unmanned vehicle (authentication information, user registration information, and the like). UE 1 101 may be a UE that manages the unmanned vehicle (for example, a UE managed by an agency that regulates the unmanned vehicle). UE 2 102 may be a UE mounted on the unmanned vehicle. For example, identification information of UE 2 102 may be included in the UAV control message 1 or UAM control message 1 110 which UE 2 102 transmits to UE 1 101.

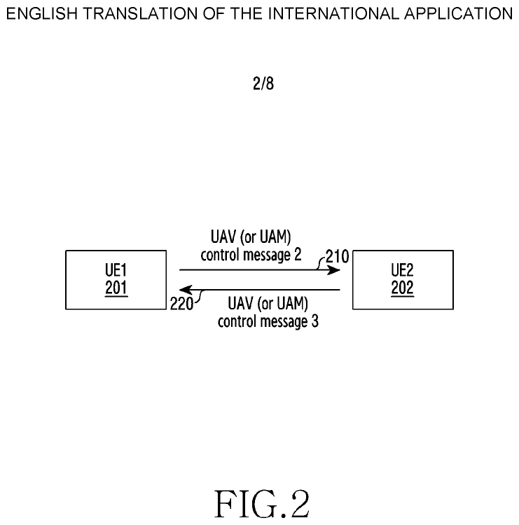

FIG. 2 illustrates a scenario of supporting an unmanned vehicle service message in a wireless communication system according to an embodiment of the disclosure.

Referring to FIG. 2, UE 1 201 and UE 2 202 may be UEs in a wireless communication system supporting unmanned vehicles. As an example, UE 1 201 may correspond to a UE managed by an agency that regulates unmanned vehicles. UE 2 202 may correspond to a UE mounted on the unmanned vehicle. As another example, UE 1 201 and UE 2 202 may correspond to UEs mounted on the unmanned vehicles.

According to an embodiment of the disclosure, UE 1 201 and UE 2 202 may broadcast (groupcast or unidirectionally/bidirectionally unicast) a UAV control message through a direct communication interface (for example, PC5 or sidelink).

Based on FIG. 2, an example of a scenario in which UE 1 201 and UE 2 202 transmit and receive unmanned mobility control signaling is described below. UE 1 201 managed by an agency that regulates the unmanned vehicle may transmit UAV (or UAM) control message 2 210 making a request for transmitting identification information to UE 2 202 mounted on the unmanned vehicle by using the direct communication interface (for example, PC5 or sidelink) in order to identify information on the unmanned vehicle (authentication information, user registration information, and the like) operated by the agency that regulates the unmanned vehicle. UE 2 202 may transmit UAV (or UAM) control message 3 220 including its own identification information to UE 1 202 by using the direct communication interface.

Further, according to an embodiment of the disclosure, at least one or a combination of UAV control message 2 210 and UAV control message 3 220 may be transmitted and received between UE 1 201 and UE 2 202 in order to make a request for stropping the flight or provide information on a flight section.

When both UE 1 101 or 201 and UE 2 102 or 202 are UEs mounted on the unmanned vehicle according to the embodiments of FIGS. 1 and 2, the UAV control messages transmitted and received by UE 1 and UE 2 may correspond to signaling including a movement path, a location (for example, 3D location information), and the like of the UE or signaling of establishing the direct communication connection to exchange messages including a movement path, a location (for example, 3D location information), and the like of the UE and configuring a direct communication connection session.

When UE 1 and UE 2 according to embodiments of FIGS. 1 and 2 transmit and receive UAV control messages by using PC5 interface-based U2X communication, the PC5 interface may correspond to an LTE RAT-based PC5 interface or an NR RAT-based PC5 interface. Accordingly, UE 1 and UE 2 should know information on whether the UAV control message can be transmitted and received using the PC5 interface-based U2X communication and information on whether the message can be transmitted and received using the LTE RAT-based PC5 interface or the NR RAT-based PC5 interface when the message can be transmitted and received using the PC5 interface-based U2X communication. Such information may be defined as a TX profile, that is, a wireless transmission profile that can be applied to UE 1 and UE 2 to transmit and receive the UAV control message by using U2X communication.

The TX profile applied to the UAV control message should be synchronized to allow UE 1 and UE 2 to transmit and receive the UAV control message by using U2X communication. That is, when the UAV control message is transmitted and received, one UE may properly receive the UAV control message transmitted by another UE only when the same TX profile is applied. When UE 1 and UE 2 do not synchronize the TX profile applied to transmit and receive the UAV control message using U2X communication, one UE cannot properly receive the UAV control message transmitted by another UE. That is, when another TX profile is applied, one UE cannot properly receive the UAV control message transmitted by another UE. Accordingly, a method of configuring and synchronizing the TX profile for U2X communication may be needed to allow UEs, which will transmit and receive the UAV control message, to use the same TX profile. Particularly, since a unicast link between UEs to transmit and receive the UAV control message is not configured, the TX profile for U2X communication may be used when wireless transmission configuration information indicating how to transmit and how to receive the UAV control message cannot be exchanged. For example, when the UAV control message is transmitted in a groupcast type or a broadcast type or is transmitted before a unicast link is configured, the TX profile for U2X communication may be used to synchronize wireless transmission configuration information between a transmission UE and a reception UE.

As an embodiment of the disclosure, the policy in [Table 3] below may be configured in the UE in order to allow the UE to transmit or receive the UAM service message or the UAV service message, based on a PC5 interface-based U2X communication. However, the disclosure is not limited thereto.

TABLE 3
PC5 RAT: indicates whether a PC5 interface of U2X communication is LTE RAT or NR
RAT or whether both RATs can be used
Cast type: indicates unicast, groupcast, or broadcast (for example, it may indicate that a
service message including a UE identifier of an unmanned vehicle is transmitted in a broadcast
type)
Frequency: a frequency designated to transmit or receive a UAV service message or a UAM
service message, based on U2X communication
RAT selection: LTE PC5 “served (or not served) by E-UTRA” or NR PC5 “served (or not
served) by NR” or LTE PC5/NR PC5 “served by E-UTRA or served by NR” or LTE PC5/NR
PC5 “not served by E-UTRA and not served by NR”
(it indicates whether LTE PC5 interface-based U2X communication can be serviced in the
E-UTRA network, NR PC5 interface-based U2X communication can be serviced in the NR
network, LTE PC5 interface-based U2X communication can be serviced in the E-UTRA
network or the NR network, NR PC5 interface-based U2X communication can be serviced in
the E-UTRA network or the NR network, LTE PC5 interface-based U2X communication can
be serviced in both the E-UTRA network and the NR network, NR PC5 interface-based U2X
communication can be serviced in both the E-UTRA network and the NR network, LTE PC5
interface-based U2X communication can be serviced in neither the E-UTRA network nor the
NR network, or NR PC5 interface-based U2X communication can be serviced in neither the E-
UTRA network nor the NR network)
Geographical area, altitude limitation, validity timer: is area information allowed to perform
U2X communication by the UE and indicates the allowed location or limited location in an
aspect of longitude, altitude, and latitude, or valid time information for area information
indicated to be allowed or limited.
U2X service identifier: ITS-AID (ITS application identifier), PSID (Provider Service
Identifier), AID (Application Identifier) according to the values for aviation applications
(identification information of the U2X service message)
PLMN: PLMN information by which the UE can perform U2X communication

As an embodiment of the disclosure, the TX profile, that is, the wireless transmission profile which can be applied to transmit and receive the UAV control message using U2X communication may be defined separately from a TX profile defined for PC5 interface-based V2X communication or PC5 interface-based proximity service (ProSe) communication.

As an embodiment of the disclosure, the TX profile which can be applied to transmit and receive the UAV service message using U2X communication and the TX profile which can be applied to transmit and receive the UAM service message using U2X communication may be defined identically or separately.

As an embodiment of the disclosure, examples of the TX profile which can be applied to transmit and receive the UAV control message using U2X communication may include [Table 4] below. However, the disclosure is not limited thereto.

TABLE 4

- “UAM(or UAV) service identifier to PC5 RAT(s) and TX profiles mapping
rules” (is PC5 RAT information and TX profile information mapped to an identifier of
the UAM service message or an identifier of the UAV service message and may be
marked as a list of several parameters or one parameter)

UAM(or UAV) service identifier: U2X service identifier: ITS-AID (ITS application
identifier), PSID (Provider Service Identifier), AID (Application Identifier) according to the
values for aviation applications

```
  - “Served by E-UTRA or served by NR” with configuration parameters for
UAV (or UAM) control message over corresponding PC5 RAT (indicates whether the
service is possible in the E-UTRA network or the NR network when the UAV service
message or the UAM service message is transmitted through corresponding PC5 RAT-
based U2X communication, and may mark a configuration parameter which can be
applied when the service is possible in each network. For example, a configuration
parameter for broadcasting a service message including identifier information of the
unmanned vehicle may be marked)
  - “Not served by E-UTRA and not served by NR” with configuration
parameters for UAV (or UAM) control message when UE is not served by E-UTRA or
NR (may mark a configuration parameter which can be applied to the case where the
service is not possible in the E-UTRA network or the NR network when the UAV
service message or the UAM service message is transmitted through corresponding
PC5 RAT-based U2X communication. For example, a configuration parameter for
broadcasting a service message including identifier information of the unmanned
vehicle, based on corresponding PC5 RAT may be marked when the service is not
possible in the E-UTRA network or the NR network.
```

A TX profile parameter may be defined for each of the LTE RAT and the NR RAT. That
is, when the UE transmits and receives the UAV/UAM service message by using the LTE RAT,
the UE may apply a TX profile parameter for the LTE RAT. Alternatively, when the UE
transmits and receives the UAV/UAM service message by using the NR RAT, the UE may apply
a TX profile parameter for the NR RAT.
Examples of the TX profile parameters for the LTE RAT are described below. A value of
rel18 corresponds to a rel18 UAV/UAM TX profile, and when the value of rel18 is configured,
it means that the UAV/UAM service message is transmitted through LTE PC5-based U2X
communication through the application of the UAV/UAM TX profile. The TX profile may be
transferred from a higher layer (upper layer) (corresponding to a higher layer (upper layer) that
can process U2X communication of the UAV/UAM such as a ProSe layer or a V2X layer) of
the UE to an access stratum (AS) layer.

| | |
|---|---|
| SL-LTE-U2X-TxProfileList-r18 ::= | SEQUENCE (SIZE (1..256)) OF SL-U2X- |

TxProfile-r18

| | |
|---|---|
| SL-LTE-U2X-TxProfile-r18 ::= | ENUMERATED {rel18, spare7, spare6, spare5, |

spare4, spare3, spare2, spare1, ...}
Examples of the TX profile parameters for the NR RAT are described below. A value of
rel18 corresponds to a rel18 UAV/UAM TX profile, and when the value of rel18 is configured,
it means that the UAV/UAM service message is transmitted through NR PC5-based U2X
communication through the application of the UAV/UAM TX profile. The TX profile may be
transferred from a higher layer (upper layer) (corresponding to a higher layer that can process
U2X communication of the UAV/UAM such as a ProSe layer or a V2X layer) of the UE to an
access stratum (AS) layer.

| | |
|---|---|
| SL-NR-U2X-TxProfileList-r18 ::= | SEQUENCE (SIZE (1..256)) OF SL-U2X- |

TxProfile-r18

| | |
|---|---|
| SL-NR-U2X-TxProfile-r18 ::= | ENUMERATED {rel18, spare7, spare6, spare5, |

spare4, spare3, spare2, spare1, ...}

As an embodiment of the disclosure, examples of the TX profile which can be applied to transmit and receive the UAV control message using U2X communication may include [Table 5] below. However, the disclosure is not limited thereto.

```
TABLE 5
  When U2X communication is performed based on the LTE RAT, examples of the TX profile
parameter for the LTE RAT are described below.
  When U2X communication is performed based on the LTE RAT, the TX profile defined for
V2X communication may be reused. That is, when the UAM service message or the UAV
service message can be transmitted through the application of the TX profile applied to Rel-14
communication or the TX profile applied to Rel-15 V2X communication for the purpose of U2X
communication, the TX profile parameter defined for V2X communication may be reused.
Since the TX profile for V2X communication can be divided into Rel-14 or Rel-15, information
indicating which TX profile (information indicating Rel-14 or Rel-15) will be applied among
TX profiles for V2X communication mapped to the UAV (or UAM) service identifier may be
transferred from a higher layer (upper layer) (corresponding to a higher layer that can process
U2X communication of the UAV/UAM such as a ProSe layer or a V2X layer) of the UE to an
access stratum (AS) layer.
```

| | |
|---|---|
| SL-V2X-TxProfileList-r15 ::= | SEQUENCE (SIZE (1..256)) OF SL-V2X-TxProfile-r15 |
| SL-V2X-TxProfile-r15 ::= | ENUMERATED {rel14, rel15, spare6, spare5, |

spare4, spare3, spare2, spare1, ...}
When U2X communication is performed based on the NR RAT, examples of the TX profile
parameter for the NR RAT are described below.

| | |
|---|---|
| SL-TxProfileList-r18 ::= | SEQUENCE (SIZE (1..256)) OF SL-TxProfile-r18 |
| SL-TxProfile-r18 ::= | ENUMERATED {drx-Compatible, drx-Incompatible, u2x- |

Compatible, u2x-Incompatible, spare4, spare3, spare2, spare1}
or

| | |
|---|---|
| SL-TxProfileList-r18 ::= | SEQUENCE (SIZE (1..256)) OF SL-TxProfile-r18 |
| SL-TxProfile-r18 ::= | ENUMERATED {drx-Compatible, drx-Incompatible, u2x, spare5, |

```
spare4, spare3, spare2, spare1}
  When NR PC5 RAT-based U2X communication can be performed, a TX profile applied to
Rel-16 V2X communication may be applied to reuse the TX profile defined for V2X
communication. At this time, information indicating a separate TX profile may not be used,
and when the NR RAT is mapped to the UAV/UAM service identifier but there is no mapping
information for the TX profile, the UE may transmit the UAV/UAM service message by
applying the TX profile applied to Rel-16 V2X communication.
  Information indicating which TX profile (information indicating Rel-14 or Rel-15) will be
applied among TX profiles for NR PC5 RATV2X communication mapped to the UAV (or
UAM) service identifier may be transferred from a higher layer (corresponding to a higher layer
that can process U2X communication of the UAV/UAM such as a ProSe layer or a V2X layer)
of the UE to an (AS) layer.
```

Information indicating a PC5 RAT and a TX profile mapped to a UAV/UAM service identifier in a higher layer (upper layer) (for example, U2X layer, V2X layer, ProSe layer, or the like) of the UE may mean the following information. The information may correspond to policy information by which the UE can use U2X communication.

| | | | | | | | |
|---|---|---|---|---|---|---|---|
| 8 | 7 | 6 | 5 | 4 | 3 | 2 | 1 |

Length of UAV (or UAM) service identifier to PC5 RAT(s) and TX
profiles mapping rule contents
UAV (or UAM) service identifiers

| | | | | | | |
|---|---|---|---|---|---|---|
| 0 | 0 | 0 | 0 | 0 | This field may be used | This field may be used to |
| Spare | Spare | Spare | Spare | Spare | as an indicator field | configure the PC5 RAT. |
| | | | | | indicating that 0 Spare | The PC5 RAT may include |
| | | | | | is configured or NR- | PC5 (E-UTRAN PC5) or NR |
| | | | | | PC5 TX profile | PC5. |
| | | | | | information is | PC5 RAT(s) |
| | | | | | configured. | (E-UTRA PC5 or NR PC5 |
| | | | | | NTI | or both) |
| | | | | | (NR-PC5 TX profile | |
| | | | | | Indicator) | |

Length of E-UTRA PC5 TX profiles
When the LTE PC5 RAT is configured, information on the TX profile may be indicated.
E-UTRA PC5 TX profiles (SL-LTE-U2X-TxProfile-r18 or SL-V2X-TxProfile-r15 of [Table 4]
or [Table 5])
When the NR PC5 RAT is configured, information on the TX profile may be indicated.
NR-PC5 TX profile (SL-NR-U2X-TxProfile-r18 or SL-TxProfile-r18 of [Table 4] or [Table 5])

Information indicating a PC5 RAT and a TX profile mapped to a UAV/UAM service identifier in a higher layer (upper layer) (for example, U2X layer, V2X layer, ProSe layer, or the like) of the UE may be information indicating whether the configured PC5 RAT-based U2X communication is supported in the E-UTRA network or the NR network.

| | | | | | | | |
|---|---|---|---|---|---|---|---|
| 8 | 7 | 6 | 5 | 4 | 3 | 2 | 1 |

Length of served by E-UTRA or served by NR contents
PLMN information for a supported E-UTRA network and PLMN
information for a supported NR network may be configured.
Authorized PLMN and RATs combinations

Information indicating a PC5 RAT and a TX profile mapped to a UAV/UAM service identifier in a higher layer (upper layer) (for example, U2X layer, V2X layer, ProSe layer, or the like) of the UE may be information indicating a parameter configuration that can be applied when the UE transmits a packet by using the corresponding PC5 RAT when the corresponding PC5 RAT-based U2X communication is not supported in the E-UTRA network and the NR network.

| | | | | | | | |
|---|---|---|---|---|---|---|---|
| 8 | 7 | 6 | 5 | 4 | 3 | 2 | 1 |

Length of not served by E-UTRA and not served by NR contents

| | | | | | | | |
|---|---|---|---|---|---|---|---|
| LTE PC5 | NR PC5 | 0 | 0 | 0 | 0 | 0 | U2X |
| indicator | indicator | Spare | Spare | Spare | Spare | Spare | communication |
| when not | when not | | | | | | over PC5 |
| served by | served by | | | | | | when not |
| E-UTRA | E-UTRA | | | | | | served by E- |
| and not | and not | | | | | | UTRA and |
| served by | served by | | | | | | not served |
| NR | NR | | | | | | by NR |

A mapping list of areas designated to use corresponding PC5-based U2X communication and E-
UTRA radio transmission parameters available in the areas. Coordinate information of a
geographical area may be expressed by a combination of longitude, latitude, and altitude.
E-UTRA radio parameters per geographical area list
A mapping list of areas designated to use corresponding PC5-based U2X communication and NR
radio transmission parameters available in the areas. Coordinate information of a geographical
area may be expressed by a combination of longitude, latitude, and altitude.
NR radio parameters per geographical area list

As an embodiment of the disclosure, examples of the TX profile which can be applied to transmit and receive the UAV control message using U2X communication may include [Table 6]below. However, the disclosure is not limited thereto.

An embodiment of [Table 6] is an example of the case where TX profile mapping when a UAV (or UAM) service identifier is serviced using LTE PC5-based U2X communication and TX profile mapping when the UAV (or UAM) service identifier is serviced using NR PC5-based U2X communication are separately configured.

```
TABLE 6
  - “UAM(or UAV) service identifier to PC5 RAT(s) and TX profiles mapping rules” for E-
  UTRA (is a TX profile mapping rule that can be applied when the PC5 RAT is LTE (E-
  UTRA) and indicates PC5 RAT information and TX profile information mapped to an
  identifier of a UAM service message or an identifier of a UAV service message, and the
  information may be expressed as a list of several parameters or one parameter.)
  - “UAM(or UAV) service identifier to NR TX profile for broadcast mapping rules” for NR
  (is a TX profile mapping rule that can be applied when the PC5 RAT is NR and may indicate
  a TX profile that can be applied when a UAM (or UAV) service message is broadcasted.
  This indicates PC5 RAT information and TX profile information mapped to an identifier of
  the UAM service message or an identifier of the UAV service message and the information
  may be expressed as a list of several parameters or one parameter.)
UAM(or UAV) service identifier: U2X service identifier: ITS-AID (ITS application identifier),
PSID (Provider Service Identifier), AID (Application Identifier) according to the values for
aviation applications
  - “Served by E-UTRA or served by NR” with configuration parameters for UAV (or UAM)
  control message over corresponding PC5 RAT (indicates whether the service is possible in
  the E-UTRA network or the NR network when the UAV service message or the UAM
  service message is transmitted through corresponding PC5 RAT-based U2X
  communication, and may express a configuration parameter which can be applied when the
  service is possible in each network. For example, this may express a configuration
  parameter for broadcasting a service message including identifier information of the
  unmanned vehicle.)
  - “Not served by E-UTRA and not served by NR” with configuration parameters for UAV
  (or UAM) control message when UE is not served by E-UTRA or NR (may mark a
  configuration parameter which can be applied to the case where the service is not possible
  in the E-UTRA network or the NR network when the UAV service message or the UAM
  service message is transmitted through corresponding PC5 RAT-based U2X
  communication. For example, when the service is not possible in the E-UTRA network or
  the NR network, a configuration parameter for broadcasting a service message including
  identifier information of the unmanned vehicle, based on the corresponding PC5 RAT, may
  be expressed. )
A TX profile parameter may be defined for each of the LTE RAT and the NR RAT. That is,
when the UE transmits and receives the UAV/UAM service message by using the LTE RAT,
the UE may apply a TX profile parameter for the LTE RAT. Alternatively, when the UE
transmits and receives the UAV/UAM service message by using the NR RAT, the UE may apply
a TX profile parameter for the NR RAT.
Examples of the TX profile parameters for the LTE RAT are described below. A value of
rel18 corresponds to a rel18 UAV/UAM TX profile, and when the value of rel18 is configured,
it means that the UAV/UAM service message is transmitted through LTE PC5-based U2X
communication through the application of the UAV/UAM TX profile The TX profile may be
transferred from a higher layer (upper layer) of the UE (corresponding to a higher layer (upper
layer) which can process UAV/UAM U2X communication such as a ProSe layer or a V2X layer)
to an access stratum (AS) layer.
```

| | |
|---|---|
| SL-LTE-U2X-TxProfileList-r18 ::= | SEQUENCE (SIZE (1..256)) OF SL-U2X- |

TxProfile-r18

| | |
|---|---|
| SL-LTE-U2X-TxProfile-r18 ::= | ENUMERATED {rel18, spare7, spare6, spare5, spare4, |

spare3, spare2, spare1, ...}
Examples of the TX profile parameters for the NR RAT are described below. A value of rel18
corresponds to a rel18 UAV/UAM TX profile, and when the value of rel18 is configured, it
means that the UAV/UAM service message is transmitted through NR PC5-based U2X
communication through the application of the UAV/UAM TX profile. The TX profile may be
transferred from a higher layer (upper layer) of the UE (corresponding to a higher layer which
can process UAV/UAM U2X communication such as a ProSe layer or a V2X layer) to an access
stratum (AS) layer.

| | |
|---|---|
| SL-NR-U2X-TxProfileList-r18 ::= | SEQUENCE (SIZE (1..256)) OF SL-U2X-TxProfile-r18 |
| SL-NR-U2X-TxProfile-r18 ::= | ENUMERATED {rel18, spare7, spare6, spare5, spare4, |

spare3, spare2, spare1, ...}
When LTE PC5 RAT-based U2X communication can be performed, the following TX profile
defined for V2X communication like the example of [Table 5] may be reused for the TX
profile that can be applied to U2X communication.

| | |
|---|---|
| SL-V2X-TxProfileList-r15 ::= | SEQUENCE (SIZE (1..256)) OF SL-V2X-TxProfile-r15 |
| SL-V2X-TxProfile-r15 ::= | ENUMERATED {rel14, rel15, spare6, spare5, |

spare4, spare3, spare2, spare1, ...}
When NR PC5 RAT-based U2X communication can be performed, the TX profile that can be
applied to U2X communication may be defined like the example of [Table 5].

| | |
|---|---|
| SL-TxProfileList-r18 ::= | SEQUENCE (SIZE (1..256)) OF SL-TxProfile-r18 |
| SL-TxProfile-r18 ::= | ENUMERATED {drx-Compatible, drx-Incompatible, u2x-Compatible, |

u2x-Incompatible, spare4, spare3, spare2, spare1}

| | |
|---|---|
| SL-TxProfileList-r18 ::= | SEQUENCE (SIZE (1..256)) OF SL-TxProfile-r18 |
| SL-TxProfile-r18 ::= | ENUMERATED {drx-Compatible, drx-Incompatible, u2x, spare5, |

spare4, spare3, spare2, spare1}

Examples of information indicating LTE PC5 RAT and TX profile mapped to a UAV/UAM service identifier in a higher layer (upper layer) (for example, U2X layer, V2X layer, ProSe layer, or the like) of the UE may mean the following information and information indicating an NR PC5 RAT and a TX profile are described below. However, the disclosure is not limited thereto. The information may correspond to policy information by which the UE can use U2X communication.

| | | | | | | | |
|---|---|---|---|---|---|---|---|
| 8 | 7 | 6 | 5 | 4 | 3 | 2 | 1 |

Length of UAV (or UAM) service identifier to PC5 RAT(s) and Tx profiles
mapping rule contents
UAV (or UAM) service identifiers

| | | | | | | |
|---|---|---|---|---|---|---|
| 0 | 0 | 0 | 0 | 0 | BNTI | PC5 RAT(s) |
| Spare | Spare | Spare | Spare | Spare | (broadcast mode NR-PC5 | (E-UTRA PC5 or NR PC5 |
| | | | | | RX profile indicator) | or both) |
| | | | | | An indicator indicating | This field may be used to |
| | | | | | whether TX profile | configure a PC5 RAT. |
| | | | | | information is included | The PC5 RAT may |
| | | | | | when NR PC5-based | include LTE PC5 (E- |
| | | | | | U2X communication is | UTRA PC5) or NR PC5. |
| | | | | | used in a broadcast mode | |

Length of E-UTRA-PC5 Tx profiles
When LTE PC5 RAT is configured, information on TX profile may be indicated.
E-UTRA-PC5 Tx profiles (SL-LTE-U2X-TxProfile-r18 or SL-V2X-TxProfile-r15 of [Table 6])
When the NR PC5 RAT is configured, information on the TX profile may be indicated. This
example may correspond to the case where NR PC5-based U2X communication is applied
in a broadcast mode.
Broadcast mode NR-PC5 Tx profile ([SL-NR-U2X-TxProfile-r18 or SL-TxProfile-r18 of
[Table 6])

Information indicating PC5 RAT and TX profile mapped to a UAV/UAM service identifier in a higher layer (upper layer) (for example, U2X layer, V2X layer, ProSe layer, or the like) of the UE may be information indicating whether the configured PC5 RAT-based U2X communication is supported in the E-UTRA network or the NR network.

| | | | | | | | |
|---|---|---|---|---|---|---|---|
| 8 | 7 | 6 | 5 | 4 | 3 | 2 | 1 |

Length of served by E-UTRA or served by NR contents
Authorized PLMN and RATs combinations

Information indicating a PC5 RAT and a TX profile mapped to a UAV/UAM service identifier in a higher layer (upper layer) (for example, U2X layer, V2X layer, ProSe layer, or the like) of the UE may be information indicating a parameter configuration that can be applied when the UE transmits a packet by using the corresponding PC5 RAT when the corresponding PC5 RAT-based U2X communication is not supported in the E-UTRA network and the NR network. Coordinate information of a geographical area may be expressed by a combination of longitude, latitude, and altitude.

| | | | | | | | |
|---|---|---|---|---|---|---|---|
| 8 | 7 | 6 | 5 | 4 | 3 | 2 | 1 |

Length of not served by E-UTRA and not served by NR contents

| | | | | | | | |
|---|---|---|---|---|---|---|---|
| EPINENN | NPINENN | 0 | 0 | 0 | 0 | 0 | VPNENNI |
| | | Spare | Spare | Spare | Spare | Spare | |

E-UTRA radio parameters per geographical area list
NR radio parameters per geographical area list

When the UAM (or UAV) service message can be transmitted using the LTE PC5 RAT-based or NR PC5 RAT-based U2X communication, information in [Table 7] below may be provided from the higher layer (upper layer) (U2X layer, V2X layer, or ProSe layer) of the UE to an access stratum (AS) layer of the UE as well as mapping information of the UAV (or UAM) service identifier, and the RAT and the TX profile. A transmission UE and a reception UE capable of performing U2X communication may transmit a U2X communication-based UAV (or UAM) service message by using information in [Table 7] below as well as the mapping information of the UAV (or UAM) service identifier, and the RAT and the TX profile. However, the transmission UE and the reception UE capable of performing U2X communication are not limited thereto.

TABLE 7
A list of UAV (or UAM) services for PPPP (ProSe Per-Packet Priority): UAV (or
UAM) service identifier and PPPP value mapping information (corresponding to QoS
information which can be applied when the LTE PC5 RAT is used)
A list of PPPP to PDB mapping rule for U2X communication over LTE PC5
A list of UAV (or UAM) services for PPPR (ProSe Per-Packet Reliability): UAV (or
UAM) service identifier and PPPR value mapping information (corresponding to QoS
information which can be applied when the LTE PC5 RAT is used)
A list of UAV(or UAM) service identifier to U2X E-UTRA frequency mapping rule
A list of UAV (or UAM) service identifier to destination layer-2 ID for broadcast
mapping rule
A list of UAV (or UAM) service identifier to PC5 QoS parameters mapping rule
(corresponding to QoS information which can be applied when the NR PC5 RAT is
used)
QoS profile (PQI), GBR QoS profiles (guaranteed flow bit rate, maximum flow bit
rate), non-GBR QoS profiles (corresponding to QoS information which can be applied
when the NR PC5 RAT is used)
A list of UAV (or UAM) service identifier to U2X NR frequency mapping rule
A default destination layer-2 ID for U2X communication over LTE PC5 • A default
destination layer-2 ID for U2X communication over NR PC5

When the UAV (or UAM) service message is transmitted using LTE PC5-based or NR PC5-based U2X communication, radio transmission parameters which can be acquired by the transmission UE and the reception UE according to TX profile information mapped to the UAV (or UAM) service identifier and the RAT may include examples of [Table 8] below. That is, the examples of [Table 8] may correspond to radio transmission parameters which can be indicated by TX profile parameters in [Table 4], [Table 5], and [Table 6]. As shown in the examples of [Table 4], [Table 5], and [Table 6], when the TX profile is configured as a value corresponding to U2X communication, the transmission UE and the reception UE may know that the parameters of [Table 8] are applied.

TABLE 8
includes a modulation and coding parameter, a MIMO layer parameter, a TX diversity
parameter, and a PPPP/PPPR/QoS profile-related parameter as a transmission
parameter and a reception parameter defined in at least one or a combination of the
existing radio transmission standards, for example, LTE Release 14 V2X
communication, LTE Release 15 V2X communication, Release 16 NR sidelink
communication, and Release 17 NR sidelink communication to support U2X
communication.
is an example of a parameter which can be configured differently from the existing
parameter (for example, at least one or a combination of LTE Release 14 V2X
communication, LTE Release 15 V2X communication, Release 16 NR sidelink
communication, and Release 17 NR sidelink communication) to support U2X
communication
a new MIMO layer (a MIMO layer parameter at an improved level than 1 layer
supported in the existing LTE PC5 and a MIMO layer parameter at an improved level
than 2 layer supported in the existing NR PC5)
New modulation and coding parameter (supporting 256 QAM - supporting 256
QAM that is not supported in the existing LTE PC5)
New QoS (additional QoS metric required for U2X communication as well as
PPPP/PPPR supported in the existing LTE PC5 and additional QoS profile/PQI required
for U2X communication as well as QoS profile/PQI supported in the existing NR PC5)
New TX diversity parameter (a TX diversity parameter which is not supported in
the existing LTE PC5 or the existing NR PC5)
New zone configuration (applying a zone configuration that considers altitude and
speed as well as a zone configuration based on longitude and latitude
Radio transmission parameters which can be used when U2X communication is supported based
on LTE PC5 or NR PC5 are not limited to the above examples.

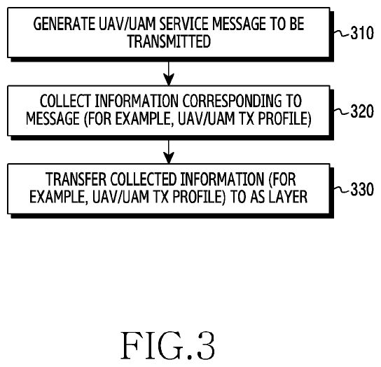

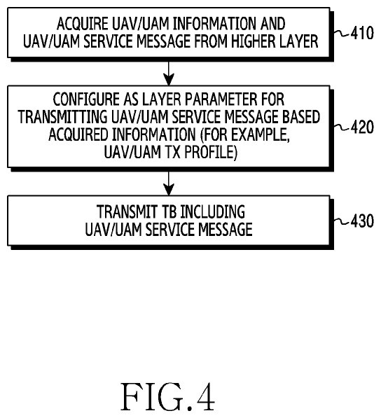

FIGS. 3 and 4 illustrate an operation of a higher layer (upper layer) (upper layer) (U2X layer, V2X layer, or ProSe layer) of the UE and an AS layer of the UE that processes transmission of a packet for a service message by processing of TX profile information configured to the UAV (or UAM) service message when the transmission UE can transmit the UAV (or UAM) service message by using LTE PC5 or NR PC5-based U2X communication. FIG. 3 illustrates the operation of the higher layer (upper layer) of the UE, and FIG. 4 illustrates the operation of the AS layer of the UE.

FIG. 3 illustrates the operation of the UE that processes a wireless transmission profile for transmitting a service message in a wireless communication system according to an embodiment of the disclosure.

Referring to FIG. 3, in operation 310, the UE may determine whether transmission of a service message generated by the UAV (or UAM) service message (or broadcast of a UE ID of the UAV or broadcast of a UE ID of the UAM) is needed. When the UAV (or UAM) service message is authenticated, the UE may transmit the UAV (or UAM) service message, and authentication information may include [Table 3].

In operation 320, the UE may collect transmission-related information corresponding to the UAV (or UAM) service message generated in operation 310. The transmission-related information corresponding to the UAV (or UAM) service message collected by the UE in operation 320 may include, for example, PC5 RAT information mapped to a service identifier of the UAV (or UAM) service message and TX profile information mapped thereto. In another example, the transmission-related information corresponding to the UAV (or UAM) service message collected by the UE in operation 320 may include at least one or a combination of [Table 4], [Table 5], [Table 6], [Table 7], and [Table 8].

In operation 330, the UE may transfer the collected transmission-related information corresponding to the UAV (or UAM) service message to the AS layer in order to transmit the generated UAV (or UAM) service message in a PC5-based U2X communication type. The information which the higher layer (upper layer) of the UE transfers to the AS layer may include examples in [Table 9] below. However, the disclosure is not limited thereto.

TABLE 9
PPPP, PPPP associated PDB, and PPPR to be used in LTE PC5
A PC5 QoS flow identifier to be used in NR PC5: is derived from a PC5 QoS mapping rule
to UAV (or UAM) service identifier
PC5 QoS flow identifier, service identifier, QoS parameters,
Destination layer-2 ID: is derived from a UAV (or UAM) service identifier to destination
layer-2 ID (a destination layer-2 ID corresponding to a broadcast mode in the case of NR PC5)
A self-assigned source layer-2 ID corresponding to a destination layer-2 ID
TX profile for a given Destination layer-2 ID, all TX and RX UEs should be configured with
the same set of TX profile(s).

FIG. 4 illustrates an operation of the UE that processes a wireless transmission profile for transmitting a service message in a wireless communication system according to an embodiment of the disclosure.

Referring to FIG. 4, in operation 410, the UE may acquire information to be referenced for selecting radio transmission parameters to be configured when a UAV (or UAM) service message (for example, UAV UE ID or UAM UE ID broadcast) and the UAV (or UAM) service message are transmitted from the higher layer (upper layer). In operation 410, examples of the information referenced by the UE may include [Table 9]. However, the disclosure is not limited thereto.

In operation 420, the UE may configure radio transmission parameters of the AS layer corresponding to the TX profile, based on the TX profile for transmitting the information, for example, the UAV (or UAM) service message acquired in operation 410. In another example, it may be determined to apply radio transmission parameters based on LTE PC5 release 14 to transmit the UAV (or UAM) service message according to the TX profile information of operation 410. In another example, the UE may determine to apply radio transmission parameters based on NR PC5 release 16 to transmit the UAV (or UAM) service message according to the TX profile information referenced in operation 410.

In operation 430, the UE may apply the radio transmission parameters determined in operation 420 to a transport block including the UAV (or UAM) service message and transmit the transport block.

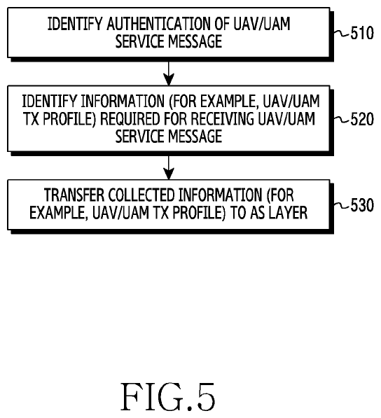

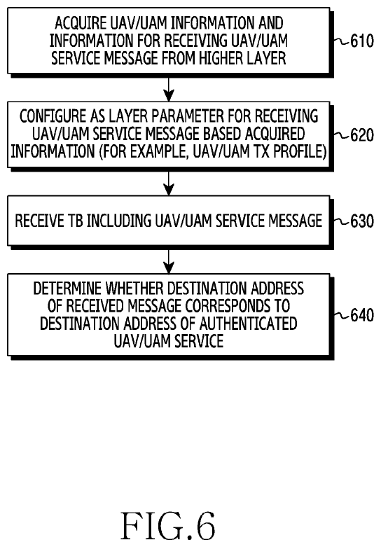

FIGS. 5 and 6 illustrate an operation of a higher layer (upper layer) (U2X layer, V2X layer, or ProSe layer) of the UE and an AS layer of the UE that processes reception of a packet for a service message by processing of TX profile information configured for the UAV (or UAM) service message when the reception UE can transmit the UAV (or UAM) service message by using LTE PC5 or NR PC5-based U2X communication. FIG. 5 illustrates the operation of the higher layer (upper layer) of the UE, and FIG. 6 illustrates the operation of the AS layer of the UE.

FIG. 5 illustrates the operation of the UE that processes a wireless transmission profile for receiving a service message in a wireless communication system according to an embodiment of the disclosure.

Referring to FIG. 5, the UE may identify whether the UE is authenticated to receive the UAV (or UAM) service message. Authentication information for the UAV (or UAM) service message may include information in [Table 3]. However, the disclosure is not limited thereto.

In operation 520, the UE may identify information required for receiving the UAV (or UAM) service message. The information required for receiving the service message in operation 520 may include a UAV (or UAM) service identifier mapped to the UAV (or UAM) service message, PC5 RAT mapped to the UAV (or UAM) service message, and TX profile information mapped to the UAV (or UAM) service message.

The UE may identify destination layer-2 ID information for receiving the UAV (or UAM) service message through PC5-based U2X communication. For example, a destination layer-2 ID corresponding to a UAV UE ID or UAM UE ID broadcast service may be configured in the UE. Such information may be used to determine whether the destination layer-2 ID of the message received from the transmission UE matches the destination layer-2 ID configured in the UAV (or UAM) service message corresponding to the received message.

In operation 530, the UE may transfer, to the AS layer of the UE, information on at least one or a combination of PC5 QoS (PQFI for NR, PPPP/PPPR for LTE), the TX profile, and the destination layer-2 ID for receiving a U2X communication message. For example, the information transferred to the AS layer in operation 530 may include [Table 9]. However, the disclosure is not limited thereto.

FIG. 6 illustrates the operation of the UE that processes a wireless transmission profile for receiving a service message in a wireless communication system according to an embodiment of the disclosure.

Referring to FIG. 6, in operation 610, the UE may acquire information required for receiving a UAV (or UAM) service message from the higher layer (upper layer) of the UE. The information acquired in operation 610 may include, for example, [Table 9]. However, the disclosure is not limited thereto.

In operation 620, the UE may configure radio transmission parameters for receiving the UAV (or UAM) service message in operation 620, based on the information acquired in operation 610.

The UE may receive TX profile information corresponding to a destination layer-2 ID corresponding to the UAV (or UAM) service message from the higher layer (upper layer). Thereafter, when receiving and processing the UAV (or UAM) service message transmitted using U2X communication, the UE may receive and process the UAV (or UAM) service message, based on the PC5 QoS and the TX profile corresponding to the destination layer-2 ID. For example, in order to receive and process a UAM UE ID or UAV UE ID broadcast service message, the UE may apply a radio transmission parameter corresponding to the TX profile configured for the UAM UE ID or UAV UE ID broadcast service.

In operation 630, the UE may receive a transport block including the UAV (or UAM) service message. In operation 630, when receiving the transport block, the UE may apply the radio transmission parameter corresponding to the TX profile.

In operation 640, the UE may determine whether the designation layer-2 ID of the received message matches the destination layer-2 ID configured in the UAV (or UAM) service message corresponding to the received message. That is, the UE may determine whether the destination of the UAV (or UAM) service message included in the received transport block is the UE. In operation 640, the operation of the UE may be processed by the higher layer (upper layer) of the UE. For example, when the AS layer of the UE receiving the transport block including the UAV (or UAM) service message knows only some of the information on the destination layer-2 ID of the UAV (or UAM) service message and thus there are restrictions on processing mapping of the destination address in operation 630, the higher layer (upper layer) of the UE may also perform the operation of identifying whether the destination address is mapped.

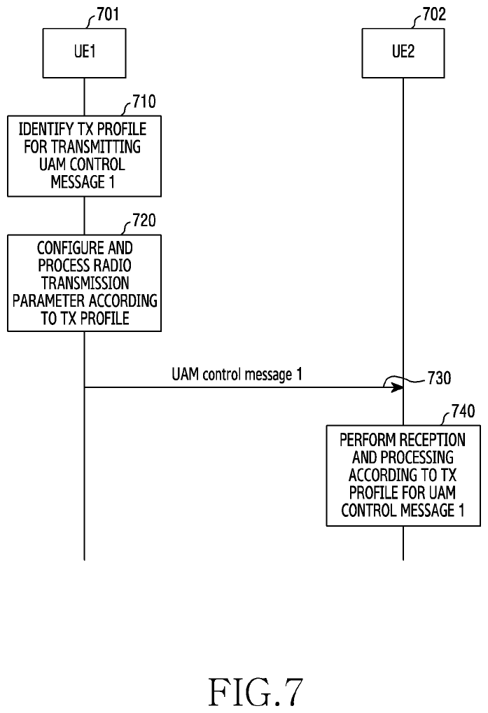

FIG. 7 is a flowchart illustrating the signal flow between UEs that process a wireless transmission profile for an unmanned vehicle service message in a wireless communication system according to an embodiment of the disclosure.

Referring to FIG. 7, UE 1 701 may correspond to a transmission UE, and UE 2 702 may correspond to a reception UE.

In operation 710, UE 1 701 may determine that transmission of UAM control message 1 corresponding to a UAV (or UAM) service message is needed and identify TX profile configuration information corresponding to the UAV (or UAM) service message to transmit the UAV (or UAM) service message.

In operation 720, UE 1 701 may determine a radio transmission parameter to be configured for transmitting UAM control message 1, based on the TX profile configuration information.

In operation 730, UE 1 701 may apply the radio transmission parameter determined in operation 720 to transmit UAM control message 1.

In operation 740, UE 2 702 may receive UAM control message 1 from UE 1 701, and apply the radio transmission parameter corresponding to the TX profile configured to apply when the UAV (or UAM) service message corresponding to UAM control message 1 is received to receive and process UAM control message 1.

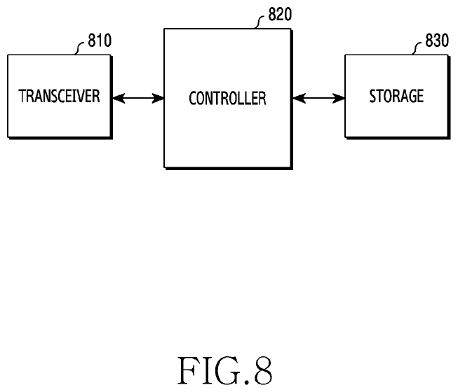

FIG. 8 illustrates a structure of a UE according to an embodiment of the disclosure.

Referring to FIG. 8, the UE may include a transceiver 810, a controller 820, and a storage 830. The transceiver 810, the controller 820, and the storage 830 may be operated according to the above-described communication methods of the UE. Components of the UE are not limited to the above-described example. For example, the UE may include a larger or smaller number of components than the above-described components. For example, the UE may include the transceiver 810 and the controller 820. Furthermore, the transceiver 810, the controller 820, and the storage 830 may be implemented in the form of a single chip.

The transceiver 810 refers to a UE receiver and a UE transmitter as a whole, and may transmit/receive signals with base stations, other UEs, or network entities. The signals transmitted/received with the base stations may include control information and data. The transceiver 810 may receive, for example, system information, synchronization signals, or reference signals from the base station. To this end, the transceiver 810 may include an RF transmitter configured to up-convert and amplify the frequency of transmitted signals, an RF receiver configured to low-noise-amplify received signals and down-convert the frequency thereof, and the like. However, this is only an embodiment of the transceiver 810, and the components of the transceiver 810 are not limited to the RF transmitter and the RF receiver. Also, the transceiver 810 may include wired/wireless transceivers, and may include various components for transmitting/receiving signals. In addition, the transceiver 810 may receive signals through a radio channel, output the same to the controller 820, and transmit signals output from the controller 820 through the radio channel. Furthermore, the transceiver 810 may receive communication signals, output same to a processor, and transmit signals output from the processor to network entities through a wired/wireless network.

The storage 830 may store programs and data necessary for operations of the UE. In addition, the storage 830 may store control information or data included in signals acquired by the UE. The storage 830 may include storage media such as a ROM, a RAM, a hard disk, a CD-ROM, and a DVD, or a combination of storage media.

As used herein, the controller 820 may be defined as a circuit, an application specific integrated circuit, or at least one processor. The processor may include a communication processor (CP) which performs control for communication and an application processor (AP) which controls upper layers such as application programs. The controller 820 may control the overall operation of the UE according to the embodiments proposed in the disclosure. For example, the controller 820 may control signal flows between the respective blocks to perform operations according to the above-described flowcharts.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1-15. (canceled)

16. A method performed by a user equipment (UE) in a wireless communication system, the method comprising:
identifying that an aerial communication supporting a unmanned aerial vehicle (UAV) service is initiated, wherein the UAV service comprises a transmission of a UAV related message;
delivering, from a higher layer to an access stratum (AS) layer, the UAV related message for the aerial communication; and
performing the aerial communication by transmitting the UAV related message over a PC5 interface based on a parameter related with the aerial communication.

17. The method of claim 16, wherein the parameter relates to a geographical area and an altitude.

18. The method of claim 16,
wherein the parameter relates to at least one of a PC5 RAT, cast mode indicating one of a unicast or a broadcast, or a public land mobile network (PLMN),
wherein the parameter related to PC5 RAT indicates whether the PC5 interface for the aerial communication is at least one of a long term evolution (LTE) PC5 RAT and a new radio (NR) PC5 RAT.

19. The method of claim 16, wherein the parameter relates to PC5 quality of service (QoS) parameter or a destination identifier (ID) for the UAV service.

20. The method of claim 16, wherein the parameter relates to a PC5 QoS flow identifier (PQI) associated with a PC5 QoS mapping rule corresponding to the UAV service.

21. The method of claim 16,
wherein the UAV related message comprises at least one of a broadcast remote identification (BRID) message and a detect and avoid (DAA) message,
wherein the higher layer comprises a UAV-to-everything (U2X) layer.

22. A user equipment (UE) comprising:
at least one transceiver;
at least one processor communicatively coupled to the at least one transceiver; and
at least one memory, communicatively coupled to the at least one processor, storing instructions executable by the at least one processor individually or in any combination to cause the UE to:
identify that an aerial communication supporting a unmanned aerial vehicle (UAV) service is initiated, wherein the UAV service comprises a transmission of a UAV related message,
deliver, from a higher layer to an access stratum (AS) layer, the UAV related message for the aerial communication, and
perform the aerial communication by transmitting the UAV related message over a PC5 interface based on a parameter related with the aerial communication.

23. The UE of claim 22, wherein the parameter relates to a geographical area and an altitude.

24. The UE of claim 22,
wherein the parameter relates to at least one of a PC5 RAT, cast mode indicating one of a unicast or a broadcast, or a public land mobile network (PLMN),
wherein the parameter related to PC5 RAT indicates whether the PC5 interface for the aerial communication is at least one of a long term evolution (LTE) PC5 RAT and a new radio (NR) PC5 RAT.

25. The UE of claim 22, the parameter relates to PC5 quality of service (QoS) parameter or a destination identifier (ID) for the UAV service.

26. The UE of claim 22, wherein the parameter relates to a PC5 QoS flow identifier (PQI) associated with a PC5 QoS mapping rule corresponding to the UAV service.

27. The UE of claim 22,
wherein the UAV related message comprises at least one of a broadcast remote identification (BRID) message and a detect and avoid (DAA) message,
wherein the higher layer comprises a UAV-to-everything (U2X) layer.

28. One or more non-transitory computer-readable storage media storing computer-executable instructions that, when executed by at least one processor of a user equipment (UE) individually or collectively, cause the UE to perform operations, the operations comprising:
identifying that an aerial communication supporting a unmanned aerial vehicle (UAV) service is initiated, wherein the UAV service comprises a transmission of a UAV related message;
delivering, from a higher layer to an access stratum (AS) layer, the UAV related message for the aerial communication; and
performing the aerial communication by transmitting the UAV related message over a PC5 interface based on a parameter related with the aerial communication.

29. The computer-readable storage media of claim 28, wherein the parameter relates to a geographical area and an altitude.

30. The computer-readable storage media of claim 29,
wherein the parameter relates to at least one of a PC5 RAT, cast mode indicating one of a unicast or a broadcast, or a public land mobile network (PLMN),
wherein the parameter related to PC5 RAT indicates whether the PC5 interface for the aerial communication is at least one of a long term evolution (LTE) PC5 RAT and a new radio (NR) PC5 RAT.
